(19) United States
(12) Patent Application Publication
(10) Pub. No.: US 2012/0052472 A1
(43) Pub. Date: Mar. 1, 2012

(54) Lesson Plan Generator

(76) Inventors: Benjamin LaFrance, Downingtown, PA (US); Rajagopalan Subrahmanian, Coatesville, PA (US)

(21) Appl. No.: 13/214,974

(22) Filed: Aug. 22, 2011

Related U.S. Application Data
(60) Provisional application No. 61/375,304, filed on Aug. 20, 2010.

(51) Int. Cl. G09B 5/00

(52) U.S. Cl. 434/322

(57) ABSTRACT

A method and system for automatically generating a lesson plan for a non-linear curriculum is disclosed.

### CROSS-REFERENCE TO RELATED APPLICATION

This application claims the benefit of U.S. patent application Ser. No. 61/375,304 filed on Aug. 20, 2010, the disclosure of which is hereby incorporated by reference as if set forth in its entirety herein.

### FIELD OF THE INVENTION

The present invention relates to methods and apparatus for generating lesson plans, and more particularly, for generating lesson plans for non-linear curricula.

### BACKGROUND

Most curricula (schools, colleges etc) are linear. You start at a certain level, you sequentially go through a set of lessons, and upon successfully completing those lessons, you go to the next level. For instance, we do not see a student in 12th grade memorizing nursery rhymes in English class.

However, in other fields (martial arts, sports, physical training, continued professional training etc), the curriculum is cyclical. For instance, a professional bodybuilder does the same exercises that a beginner does, except at a different level and intensity. Martial artists work on the same basic techniques they were taught when they first started. The student learns a series of techniques and concepts and these are continuously trained and reinforced throughout his career in that field. In addition, in such fields, a single class is shared by people at different levels in their skills, abilities and experience.

### SUMMARY

In the types of non-linear curricula described above, each class session has to be tailored such that the entire curriculum is covered over a period of time (for instance, a trainer cannot just choose upper body workouts class after class) and that people at all levels are catered to. Generating lesson plans automatically for classes with non-linear curricula and containing students of multiple skill levels like the ones described above is thus a unique problem. This application is directed to a lesson plan generator that provides a solution to this problem.

In one embodiment, a method for generating a lesson plan comprises receiving information defining each of a plurality of different lesson plan units and associating each lesson plan unit with at least one topic and at least one level. The information defining each lesson plan unit may be stored along with tags indicating which topics and levels have been associated with that lesson plan unit. Information comprising an outline of a class may the be received, the outline of the class identifying topics that an instructor would like covered in the class. For each topic identified in the outline, a lesson plan unit associated with that topic is automatically chosen for each level. In one embodiment, each time a lesson plan is generated for the outline, different lesson plan units are chosen for each topic and for each level based on a determination of which lesson plan units have been least recently chosen.

### BRIEF DESCRIPTION OF THE DRAWINGS

A more detailed understanding may be had from the following description, given by way of example in conjunction with the accompanying drawings wherein:

FIG. 1 illustrates one embodiment of a display screen by which a user may create a topic;

FIG. 2 illustrates one embodiment of a display screen by which a user may create a level;

FIG. 3 illustrates one embodiment of a display screen by which a user may create a drill;

FIG. 4 illustrates an example in which a user has made certain selections;

FIG. 5 illustrates one embodiment of a display screen by which a user may save a lesson plan;

FIG. 6 illustrates one embodiment of a display screen by which a user may load a previously saved lesson plan; and

FIG. 7 illustrates, by way of one example, how upon subsequent selection of a same lesson plan, the lesson plan generator automatically rotates through the drills to pick a different drill for each level, in accordance with an embodiment of the methods disclosed herein;

FIG. 8 is a flow diagram illustrating one embodiment of a lesson plan generation method; and

FIG. 9 a block diagram of an example computer system on which the lesson plan generator and/or all or some of its various components or steps may be implemented

### DETAILED DESCRIPTION

The following is a description of one example embodiment of a lesson plan generator. In the following description, the lesson plan generator is described in the context of an example in which it is used to generate lesson plans for a martial arts curriculum. In other embodiments, the lesson plan generator may be used to generate lesson plans for other non-linear curricula.

In one embodiment, the lesson plan generator operates upon three types of entities:

(1) Lesson Plan Units (LPU): These are the atomic activities that comprise a class. In the example of a martial arts class, these Lesson Plan Units take the form of Drills, such as pushups, specific blocks and counter-strikes, specific strikes (jab, cross etc). In the example of a math class, these Lesson Plan Units could be such things as trigonometry problems, integral calculus etc.

(2) Topics: These are the topics that the instructor tries to impart to the students. In the martial arts example, these would for instance be such things as ‘self-defense’, ‘body-connection’, ‘throwing techniques’ etc.

(3) Levels: These represent the different levels of students. In the martial arts example, students progress through levels identified by “belt” rank, such as white-belt, yellow-belt, green-belts, etc.

Again, it is understood that the lesson plan generator described herein is not limited to martial arts curriculums. For instance, with a fitness training curriculum, you may have Lesson Plan Units such as pushups, situps and squats, Topics such as upper-body-strength, core training, cardiovascular fitness etc, and Levels such as beginner, intermediate and advanced.

Once the Lesson Plan Units of the curriculum are defined, the lesson plan generator provides the instructor with a way to ‘mark’ these Lesson Plan Units with appropriate levels and topics which may be defined by the instructor. Each Lesson Plan Unit is stored, for example in a non-volatile memory, along with tags indicating which topics and levels that Lesson Plan Unit belongs to. In one embodiment, there are no limits on the number of levels or topics to which a Lesson Plan Unit may belong.

In accordance with the inventive methods described herein, the instructor may use the lesson plan generator to create a lesson outline consisting of the topics that the instructor would like covered in a given class. The lesson plan generator then automatically chooses the Lesson Plan Unit appropriate for that topic for each of the levels that have been defined. In one embodiment, the lesson plan generator chooses the Lesson Plan Unit that has not been used for the greatest period of time. Specifically, in one embodiment, there is a queue of Lesson Plan Units and the Lesson Plan Unit that has been used most recently is pushed to the end of the queue each time, so that there is full coverage among the Lesson Plan Units.

In an embodiment, the lesson plan generator may rotate between the topics automatically as well, and generate the lesson plans automatically, given time constraints.

In one embodiment, a hierarchy may be created among the different Lesson Plan Units so that they appear in the plan more or less per cycle. So, a Lesson Plan Unit which has twice the importance as another may show up in lesson plans twice as often over a period of time.

The lesson plan generator provides instructors with the flexibility to design and develop their own topics, levels and Lesson Plan Units that go with these topics and levels. And it allows them to create lesson plan outlines and then automatically generate the lesson plans based on the outline.

Again, it must be noted that this method is not limited to martial arts or physical curriculum. This can be applied to any situation where a curriculum needs to be applied to a multi-level classroom. For instance, in a school classroom, this would permit the teacher to design lesson plan outlines that are tailored to specific students or groups of students which then the program would use to automatically generate a lesson plan for each class.

In one embodiment, the lesson plan generator comprises a computer program in the form of a Windows® forms-based application that creates a lesson plan for a school, such as for example, a martial arts school. In such an example, a single Lesson Plan Unit is a drill. The lesson plan generator has multiple forms to add, remove and edit drills, levels and topics. In the drills form, it is possible to associate levels and topics with drills. The drills, topics and associations are stored in a database for subsequent retrieval.

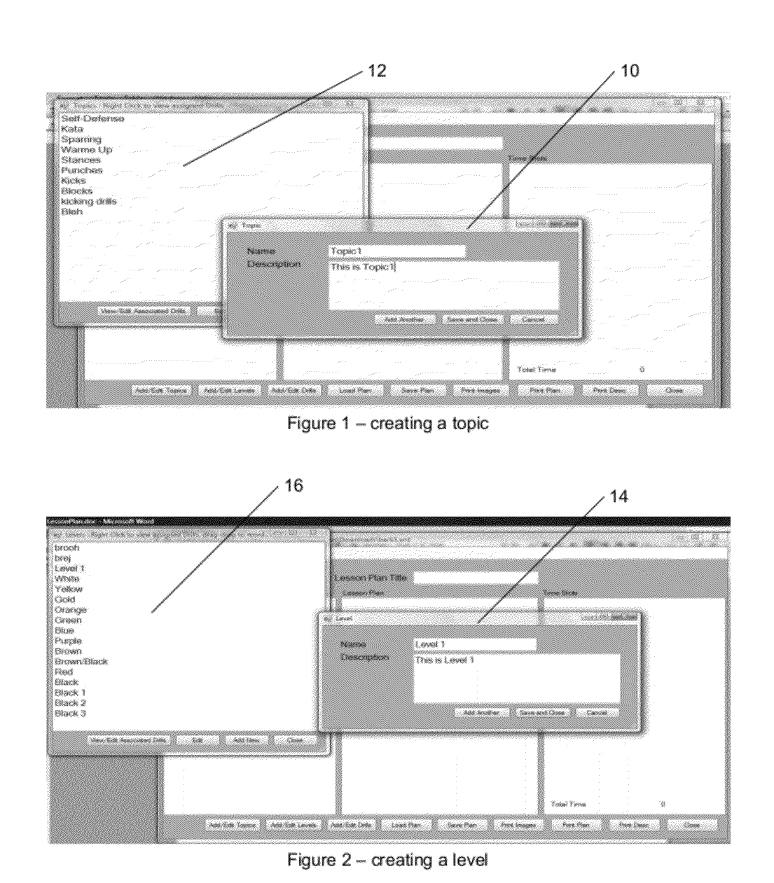

Initially, there may be no drills, levels or topics. The program may allow the user to create these. FIG. 1 is a screen shot illustrating how a user may create a topic. As shown, a pop-up window 10 is provided to allow the user to create a new topic. Another pop-up window 12 displays existing topics. A user can right-click an existing topic to view the assigned drills for that topic. FIG. 2 is a screen shot illustrating how a user may create a level. As shown, a pop-up window 14 is provided to allow the user to create a new level. Another pop-up window 12 displays existing levels.

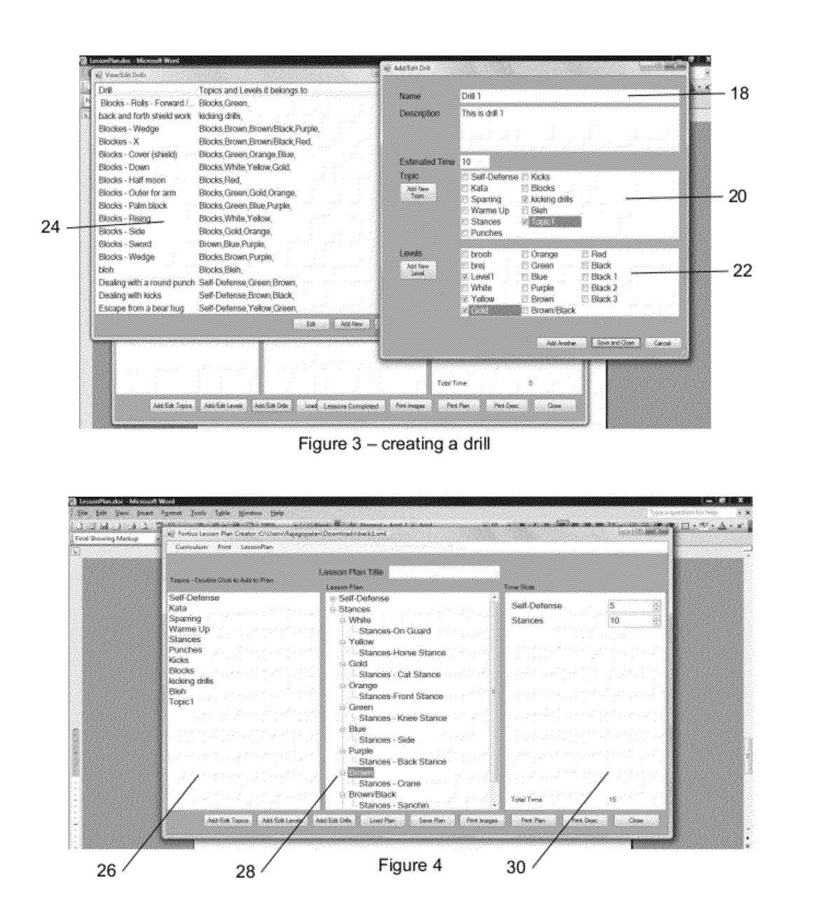

FIG. 3 is a screen shot illustrating how a user may create a drill. As the drills are being created, the system shows a list of topics and levels that can be associated with it. In this particular case, the Drill 1 has been associated with Topic1, Kicking drills and the levels Level1 and yellow. It is this ability to associate drills (which are discreet lesson units), with multiple topics and levels that is the enabling technology for creating dynamic, automated lesson plans. In FIG. 3, a user may enter a name for a drill in field 18. Topics that a user can associate with the drill are shown in field 20. A user clicks on the radio button next to a given topic to associate it with a drill. An associated topic is shown with a check mark in the radio button. Levels that a user can associate with the drill are shown in field 22. Another window 24 shows existing drills along with the topics and levels to which it belongs (i.e., with which it is associated).

FIG. 4 shows the main screen of the lesson plan generator. In the main screen, the topics are listed in the pane 26 on the left hand side. Double clicking on a topic adds it to a lesson plan. As each topic is added, the system automatically goes through the list of drills and for each level, picks a drill associated with that topic and level based on which drill has not been used for the longest time. It then marks the drill with the current time, which is stored as metadata for the drill. This moves the drill to the head of the list of drills used. This ensures that all applicable drills are used in rotation. As topics are selected, they appear in the central pane 28.

In the screen shot shown in FIG. 4, the instructor has chosen topics “self-defense,” followed by “stances.” The stances topic has been expanded for illustration. Individual levels can be deleted, for instance if the instructor wants to focus on only a certain group of students for that class. The drill with the longest time-slot will be used to calculate the time to be spent on that topic. This too can be edited by the instructor. Time slots can be established in the right-hand pane 30.

Once the lesson plan has been designed, the instructor can save the lesson plan and load it at a later date. When the lesson plan is loaded at that later time, the lesson plan will be loaded with the drills that have not been used the longest for each level and topic (as discussed previously). This ensures that over time, the instructor gets coverage for all the drills.

Thus, by allowing the instructor to associate drills with arbitrary numbers of topics and levels, cycling through the drills based on when they were used, this system allows the automatic generation of lesson plans. The instructor merely chooses the topics that need to be covered in a day, and the system takes care of the rest.

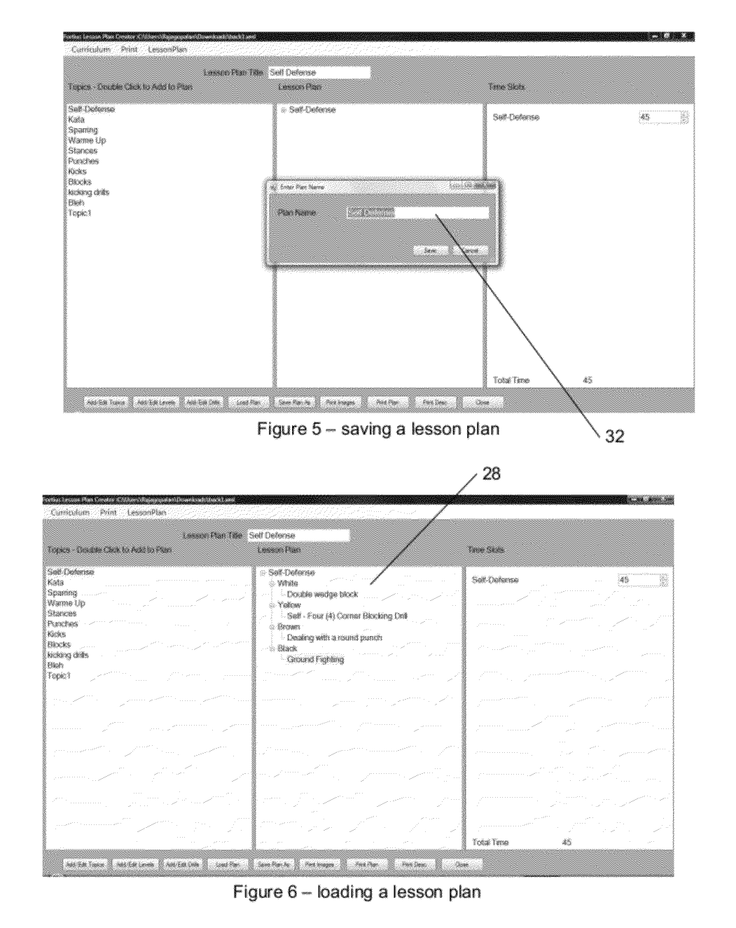

At the next level, once the lesson plans are created, the system can automatically generate the lesson for all the levels of students that need be taught on a given day. FIG. 5 is a screen shot illustrating the saving of a simple lesson plan created by an instructor. The user enters a name for the lesson plan in field 32 and then presses “Save.” In this example, the students will train self-defense for an entire 45 minutes.

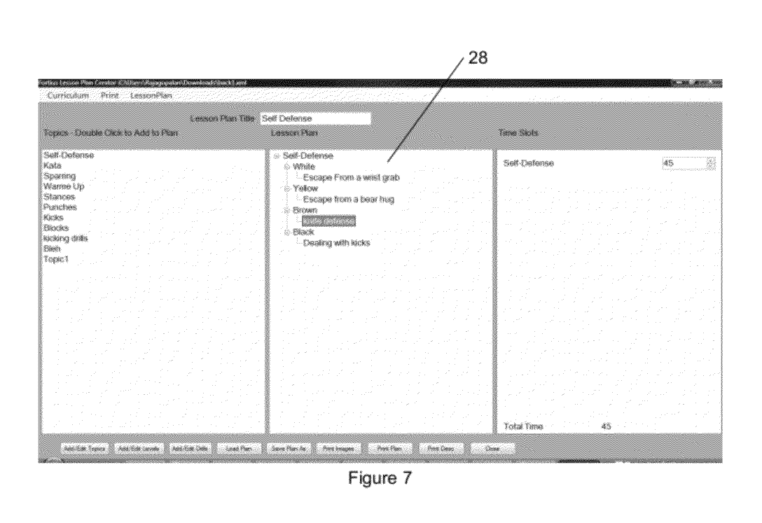

FIG. 6 is a screen shot illustrating loading of a previously saved lesson plan. As shown in the central pane 28, when the instructor loads this lesson plan, we see that the system has automatically chosen drills for all the levels. For example, the system has chosen the “Double wedge block” drill for the “White” level, and has chosen the “Dealing with a round punch” drill for the “Brown” level. The next time that the same lesson plan is chosen, the system will automatically rotate through the drills to pick up a different drill for each level. Again, in one embodiment, the system automatically picks the least recently used drill for each level. This is shown in FIG. 7. For example, this time the drill “Escape From a wrist grab” has been chosen for the “White” level and the drill “knife defense” has been chosen for the “Brown” level. In this way, the system solves the problem laid out at the beginning of this text: automating lesson plan generation for non-linear curricula where students of multiple levels might need to be taught in the same class.

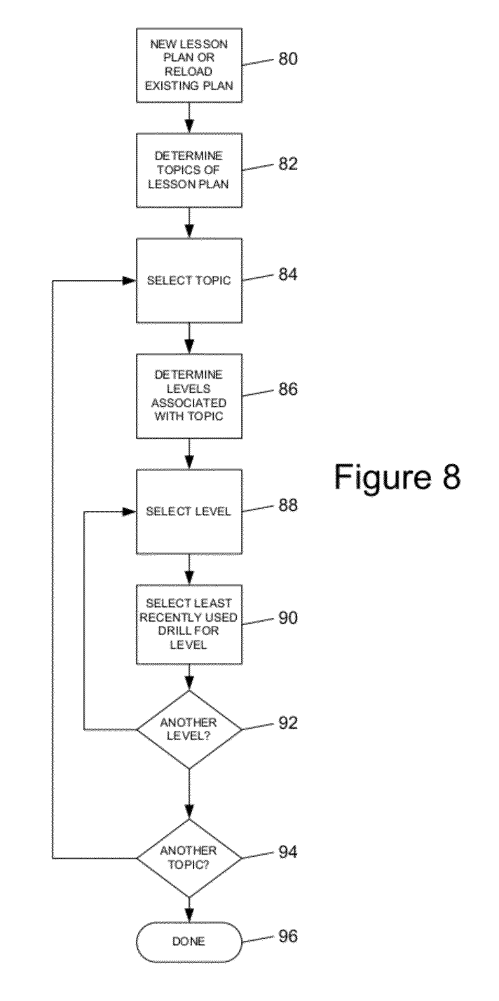

FIG. 8 is a flow diagram illustrating one embodiment of a method for generating a lesson plan in the manner described above. As shown, the process may begin at step 80, where a plan is to be generated either for the first time for a new lesson plan or upon reloading a previously generated lesson plan. At step 82, the topics associated with the lesson plan are determined. In one embodiment, the list of topics selected by an instructor for a given lesson plan is stored as metadata associated with the lesson plan. The generator retrieves this metadata upon loading the lesson plan.

Next, at step 84, a first one of the topics of the lesson is selected for further processing. At step 86, the levels associated with the topic are determined. For example, in the example shown in FIGS. 6 and 7, the “Self-Defense” topic may have levels “White,” “Yellow,” “Brown” and “Black” associated with it in the current lesson. There may be other levels associated with the topic that the instructor has not chosen for this particular lesson plan. The information about which levels are associated/chosen for the selected topic in this lesson plan may be stored as metadata associated with the lesson plan. Alternatively, the information could be stored in a separate database.

Next, at step 90, the generator identifies the list of lesson plan units (i.e., drills in this example) associated with the selected level and then selects the one that is least recently used. As mentioned above, each time a drill is selected for a given generation of a lesson plan, a timestamp may be stored to indicate the date/time of its use in the lesson plan. Upon subsequent generations of the same lesson plan, the generator may access those timestamps in order to select the drill that has been least recently used. In other embodiments, the different drills may be stored in the form of a circular buffer, and the generator may simply cycle through the circular buffer. Either way, a result of this process is that for each generation of the lesson plan, the different drills for each level of a topic are generally cycled through substantially evenly to ensure relatively uniform use of the different drills over time.

Next, at step 92, a determination is made as to whether there are any more levels to process. If so, control passes back to step 88 where the next level for the selected topic is chosen. Drill selection is then repeated for that next level.

If no more levels are associated with the currently selected topic, control passes to step 94 where it is determined whether there are any additional topics for the lesson. If so, control passes back to step 84 where the next topic is selected. Processing for that next topic then proceeds in the same manner through steps 86-94. Once all of the topics have been processed, the process ends at step 96.

For teachers, this provides a very powerful tool for organizing and presenting their curriculum to students of multiple skill levels. Though this software has been created for the domain space of a martial arts curriculum, this can quite easily be changed to address the needs of teachers and instructors in other fields. The embodiment described above may provide easy creation of lesson plans, as once the topics are chosen, the rest of the lesson plan may be automatically generated. The described embodiment may also provide the ability to save the lesson plan and have it generate a new lesson each time it is reloaded, based on the stored information.

Additionally, this method is a powerful way of recording and making sense of complicated information since it provides a way of associating discrete components of knowledge (drills in this particular implementation) with much more general concepts (topics and levels in this implementation). It allows a mapping to be created of what components of information exist, and how they relate to each other and to other categories. For instance, consider this piece of information ‘Some dogs have been known to be able to smell certain cancers in patients’. In our methodology, this chunk of information would get associated with the categories dog, cancer, diagnosis. So, this chunk of information is available to any program or person who is searching those categories. Allowing the domain expert to do the actual association is a significant innovation.

In the current method of recording information, especially for teaching (such as lessons, textbooks, manuals etc), we depend on categories and drill down to the components, in a top-down fashion. But this proves very difficult when the knowledge belongs to multiple categories. Using the methods employed by the Lesson Plan Generator described above, that problem may be taken away, since we are going bottom-up, from the knowledge components into the concepts and categories.

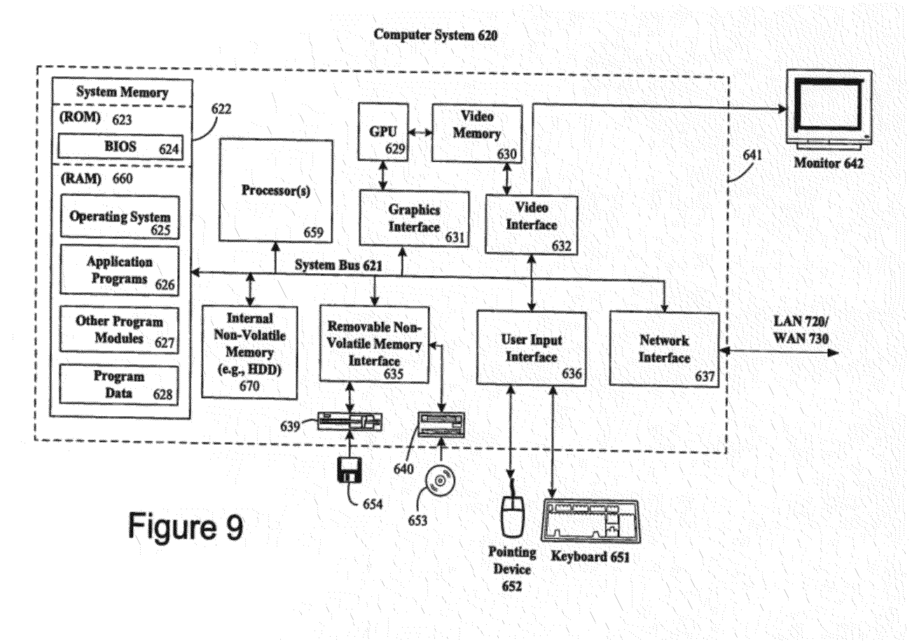

FIG. 9 is a block diagram of an example computer system 620 on which the lesson plan generator described above and/or all or some of its various steps, elements or components may be implemented. The computer system 620 is only one example of a suitable computing environment and is not intended to suggest any limitation as to the scope of use or functionality of the presently disclosed subject matter. Neither should the computer system 620 be interpreted as having any dependency or requirement relating to any one or combination of components illustrated in FIG. 9. In some embodiments, the various depicted computing elements may include modules or components configured to instantiate specific aspects of the present disclosure. For example, the terms “module” or “component” used in this description may include specialized hardware components configured to perform function(s) by firmware or switches. In other example embodiments, the terms “module” and “component” may include a general purpose processor, memory, etc., configured by software instructions that embody logic operable to perform function(s). In example embodiments where modules or components include a combination of hardware and software, an implementer may write source code embodying logic and the source code can be compiled into machine readable code that can be processed by the general purpose processor. Since the state of the art has evolved to a point where there is little difference between hardware, software, or a combination of hardware/software, the selection of hardware versus software to effectuate specific functions is a design choice left to an implementer. More specifically, a software process can be transformed into an equivalent hardware structure, and a hardware structure can itself be transformed into an equivalent software process. Thus, the selection of a hardware implementation versus a software implementation is one of design choice and left to the implementer.

In FIG. 9, the computer system 620 comprises a computer 641, which typically includes a variety of computer readable media. Computer readable media can be any available media that can be accessed by computer 641 and includes both volatile and nonvolatile media, removable and non-removable media. The system memory 622 includes computer storage media in the form of volatile and/or nonvolatile memory such as read only memory (ROM) 623 and random access memory (RAM) 660. A basic input/output system 624 (BIOS), containing the basic routines that help to transfer information between elements within computer 641, such as during start-up, is typically stored in ROM 623. RAM 660 typically contains data and/or program modules that are immediately accessible to and/or presently being operated on by processing unit 659. By way of example, and not limitation, FIG. 9 illustrates operating system 625, application programs 626, other program modules 627, and program data 628.

The computer 641 may also include other removable/non-removable, volatile/nonvolatile computer storage media. By way of example only, the computer 641 may include a hard disk drive 670 that reads from or writes to non-removable, nonvolatile magnetic media, a magnetic disk drive 639 that reads from or writes to a removable, nonvolatile magnetic disk 654, and an optical disk drive 640 that reads from or writes to a removable, nonvolatile optical disk 653 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Magnetic disk drive 639 and optical disk drive 640 are typically connected to the system bus 621 by a removable memory interface, such as interface 635. The drives and their associated computer storage media discussed above and illustrated in FIG. 9, provide storage of computer readable instructions, data structures, program modules and other data for the computer 641.

A user may enter commands and information into the computer 641 through input devices such as a keyboard 651 and pointing device 652, commonly referred to as a mouse, trackball or touch pad. Other input devices (not shown) may include a microphone, joystick, game pad, satellite dish, scanner, or the like. These and other input devices are often connected to the processing unit 659 through a user input interface 636 that is coupled to the system bus, but may be connected by other interface and bus structures, such as a parallel port, game port or a universal serial bus (USB). The computer may connect to a local area network or wide area network, such as LAN 720 and/or WAN 730, through a network interface or adapter 637.

As the foregoing illustrates, all or portions of the methods and systems described herein may be embodied in hardware, software, or a combination of both. When embodied in software, the methods and apparatus of the present invention, or certain aspects or portions thereof, may be embodied in the form of program code (i.e., computer executable instructions). This program code may be stored on a computer-readable storage medium, such as a magnetic, electrical, or optical storage medium, including without limitation, a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer or server, the machine becomes an apparatus for practicing the invention. As used herein, the term computer-readable storage medium does not encompass a signal nor a carrier wave. A device on which the program code executes, such as a computing device, will generally include a processor, a storage medium readable by the processor (including volatile and non-volatile memory and/or storage elements), at least one input device, and at least one output device. The program code may be implemented in a high level procedural or object oriented programming language. Alternatively, the program code can be implemented in an assembly or machine language. In any case, the language may be a compiled or interpreted language. When implemented on a general-purpose processor, the program code may combine with the processor to provide a unique apparatus of system that operates analogously to specific logic circuits.

While systems and methods have been described and illustrated with reference to specific embodiments, it is understood that modifications and variations may be made without departing from the principles described above and set forth in the following claims. Accordingly, reference should be made to the following claims as describing the scope of the disclosed subject matter.

What is claimed:

1. A computer-implemented method of generating a lesson plan, comprising:
receiving, by a processor of a computer system, information defining each of a plurality of different lesson plan units;
associating, by the processor, each lesson plan unit with at least one topic and at least one level;
storing, in a memory of the computer system, the information defining each lesson plan unit along with tags indicating which topics and levels have been associated with that lesson plan unit; and
receiving, by the processor, information comprising an outline of a class, the outline of the class identifying topics that an instructor would like covered in the class; and
for each topic identified in the outline, automatically choosing, by the processor, a lesson plan unit associated with that topic for each level.

2. The method recited in claim 1, wherein each time a lesson plan is generated for the outline, different lesson plan units are chosen for each topic and for each level based on a determination of which lesson plan units have been least recently chosen.

3. A computer readable storage medium comprising instructions which, when executed by a processor, perform the steps recited in claim 1.

4. A computer system comprising a processor and a memory, wherein the processor is configured to:
receive information defining each of a plurality of different lesson plan units;
associate each lesson plan unit with at least one topic and at least one level;
store in the memory the information defining each lesson plan unit along with tags indicating which topics and levels have been associated with that lesson plan unit; and
receive information comprising an outline of a class, the outline of the class identifying topics that an instructor would like covered in the class; and
for each topic identified in the outline, automatically choose a lesson plan unit associated with that topic for each level.
